(19) United States
(12) Patent Application Publication
(10) Pub. No.: US 2010/0146003 A1
(43) Pub. Date: Jun. 10, 2010

(54) Method and system for building a B-tree

(75) Inventors: Kelsey L. Bruso, Minneapolis, MN (US); James M. Plasek, Shoreview, MN (US)

Correspondence Address: UNISYS CORPORATION, UNISYS WAY, MAIL STATION: E8-114, BLUE BELL, PA, 19424, US

(73) Assignee: Unisys Corporation

(21) Appl. No.: 12/154,292

(22) Filed: Dec. 10, 2008

(51) Int. Cl. G06F 7/00

(52) U.S. Cl. 707/797; 707/E17.044

(57) ABSTRACT

Various approaches for adding data items to a database are described. In one approach, a method includes receiving a plurality of data items; each data item is to be stored under a unique primary key in the database. In response to each received data item, one of a plurality of fragment builders is selected and the data item is provided as input to the selected fragment builder. The fragment builders operate in parallel to create respective pluralities of B-tree fragments from the input data items. The B-tree fragments are merged into a single B-tree of the database, which is then stored.

### FIELD OF THE INVENTION

The present invention generally relates to building a B-tree for a database.

### BACKGROUND

Computers are used today to store large amounts of data. Such information is often stored in information storage and retrieval systems referred to as databases. This information is stored and retrieved from a database using an interface known as a database management system (DBMS).

One type of DBMS is called a Relational Database Management System (RDBMS). An RDBMS employs relational techniques to store and retrieve data. Relational databases are organized into tables, wherein tables include both rows and columns, as is known in the art. A row of the horizontal table may be referred to as a record.

One type of data structure used to implement the tables of a database is a B-tree. A B-tree can be viewed as a hierarchical index. The root node is at the highest level of the tree, and may store one or more pointers, each pointing to a child of the root node. Each of these children may, in turn, store one or more pointers to children, and so on. At the lowest level of the tree are the leaf nodes, which typically store records containing data.

In addition to the pointers, the nodes of the B-tree also store key values used for searching the tree for records. For instance, assume a node stores a first key value, and first and second pointers that each point to a child node. According to an example organizational structure, the first pointer may be used to locate the child node storing one or more key values that are less than the first key value, whereas the second pointer is used to locate the child storing one or more key values greater than, or equal to, the first key. Using the key values and the pointers to search the tree in this manner, a node may be located that stores a record associated with a particular key value that is used as the search key. A B+tree is a special B-tree in which interior nodes in the tree contain key values, and all records of the database are stored in or pointed to by leaf nodes.

DBMS applications typically build B-trees according to the following process. The DBMS application obtains a first record having a first key value that is to be added to new B-tree. A root node is created that points to a leaf node, and the record is stored within the leaf node. When a second record is received, the key value stored within the root node and the second record will be used to determine whether the second record will be stored within the existing leaf node or within a newly created leaf node. The point of insertion will be selected so that all records are stored in a sort order based on the key values. Similarly, as additional records are received, the records are added to the tree by traversing the tree structure using the key values to locate the appropriate location of insertion, then adding leaf nodes as necessary. Whenever it is determined that the root or an intermediate node has too many children, that node is divided into two nodes, each having some of the children of the original node. Similarly, if it is determined that a record must be added to a leaf node that is too full to receive the record, the leaf node must be split to accommodate the new addition.

Relational databases are used to store many kinds of data for later retrieval and analysis. Data that in the past would have been stored to flat files or simply to tape are increasingly being written to relational databases to allow the data to be shared among users and to be analyzed with the many tools which operate against relational data. Examples of databases with this kind of data include: telephone switch information for initiation and termination of calls, satellite telemetry data, manufacturing process monitoring data, and stock market trade data.

These types databases have two characteristics in common. First, their primary key is an always increasing value and often it includes a timestamp. Second, the insert rate required of the database management system to store the data is extremely high. Databases with this kind of data may have other secondary indexes, for example, telephone number, latitude and longitude, stock name, and so on. Such secondary indices may also uniquely identify records in the database but they are not based on the primary key.

These kinds of systems are often called “streaming databases” where the general problem is called “stream data handling.” Because of the high rate of arrival of new data items which must be inserted into the database, some technique must be used to manage the volume. In the past, several techniques were used to work around the data volume. These techniques group into three general areas: filtering the data to reduce the volume, splitting the data into multiple relational databases, or using specialized data management techniques which are not relational databases. None of these solutions meets the goal of high volume, near-real-time inserts into a common database.

A method and system that address these and other related issues are therefore desirable.

### SUMMARY

The various embodiments of the invention provide methods and systems for adding data items to a database. In one embodiment, a method comprises receiving a plurality of data items. Each data item is to be stored under a unique primary key in the database. In response to each received data item, the method selects one of a plurality of fragment builders and provides the received data item as input to the selected fragment builder. Respective pluralities of B-tree fragments are built by the fragment builders, which operate in parallel. The pluralities of B-tree fragments are merged into a single B-tree of the database, which is thereafter stored.

In another embodiment, a system is provided for adding data items to a database. The system comprises a data processing system for receiving a plurality of data items. Means, responsive to each received data item, are provided for selecting one of a plurality of fragment builders and providing the received data item as input to the selected fragment builder. The system also includes means for generating and storing respective pluralities of B-tree fragments by the fragment builders from the input data items. Means for merging the pluralities of B-tree fragments into a single B-tree of the database, and means for storing the single B-tree are also included in the system.

A system for adding a plurality of data items to a single B-tree of a relational database is provided in another embodiment. The system includes a first data processing system executing a first operating system and a router. The router receives the plurality of data items, and for each received data item selects one of a plurality of fragment builders and transmits the data item to the selected fragment builder. The system also includes at least one second data processing system. Each second data processing system is coupled to the first data processing system and executes a respective second operating system and one or more of the fragment builders. Each of the one or more fragment builders creates B-tree fragments from data items transmitted from the router to that fragment builder and provides the B-tree fragments to a first component for merging. A third data processing system is coupled to the at least one second data processing system and executes a third operating system and the first component for merging. The first component for merging combines each B-tree fragment provided from a fragment builder into a first single B-tree of a first database.

The above summary of the present invention is not intended to describe each disclosed embodiment of the present invention. The figures and detailed description that follow provide additional example embodiments and aspects of the present invention.

### BRIEF DESCRIPTION OF THE DRAWINGS

Other aspects and advantages of the invention will become apparent upon review of the Detailed Description and upon reference to the drawings in which:

FIG. 1 is a block diagram of an example data processing system;

FIG. 2A is a functional block diagram that shows a router, multiple B-tree fragment builders, and a component for merging for building a relational database in accordance with various embodiments of the invention;

FIG. 2B is a functional block diagram that shows an alternative embodiment of the invention in which multiple components for merging create respective B-trees from B-tree fragments;

FIG. 2C is a block diagram that shows an embodiment of the invention in which individual physical data processing systems are used to host the router, B-tree fragment builders, and the component for merging, and the B-tree fragment builders store the B-tree fragments to a storage arrangement that is shared with the component for merging;

FIG. 2D is a flowchart of an example process performed by the router in accordance with various embodiments of the invention;

FIG. 2E is a flowchart of an example process performed by each B-tree fragment builder component in accordance with various embodiments of the invention;

FIG. 2F is a flowchart of an example process performed by the component for merging in accordance with various embodiments of the invention;

FIG. 2G shows the merging of example B-trees into a single B-tree;

FIG. 2H shows an example database having three partitions;

FIG. 3 shows an example B-tree constructed from an input stream of sorted records;

FIGS. 4A and 4B, when arranged as shown in FIG. 4, are a flow diagram illustrating a process by which the example B-tree of FIG. 3 may be constructed;

FIG. 5 is a diagram illustrating a main B-tree and a fragment B-tree to be merged with the main B-tree;

FIG. 6 is a diagram illustrating the B-tree fragment of FIG. 5 having been merged into the main B-tree;

FIGS. 7A through 7D, when arranged as shown in FIG. 7, are a flow diagram illustrating one embodiment of the process of merging a B-tree fragment onto a main B-tree in a manner that maintains a balanced tree structure; and

FIG. 8 is a flow diagram illustrating a generalized embodiment of the merging process that creates a balanced tree structure.

### DETAILED DESCRIPTION

The various embodiments of the invention employ multiple systems working in parallel to build B-tree fragments which are then applied to a single B-tree of a relational database. One or more routers receive data items from one or more data sources. The data items contain information that is to be stored in the relational database. The data items are distributed amongst multiple B-tree fragment builders for building B-tree fragments. The B-tree fragment builders provide the fragments to one or more components for merging, and each component for merging merges each received B-tree fragment with the main B-tree of the relational database. It will be appreciated by those skilled in the art that the inventive concepts described herein may be applied to the construction of both B+trees and B-trees, as well as other types of hierarchical tree structures.

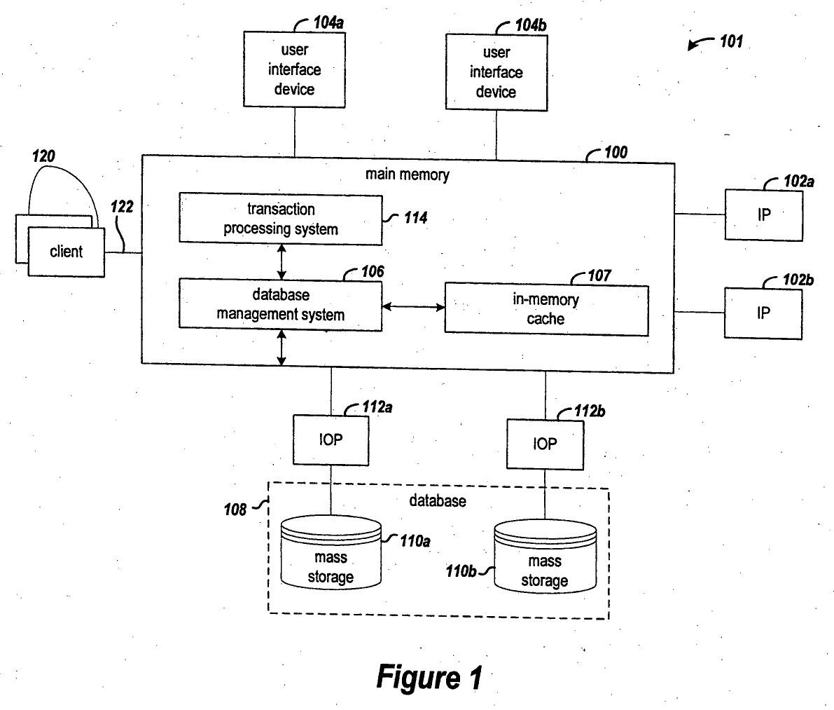

FIG. 1 is a block diagram of an example data processing system 101 that may usefully employ the current invention. The data processing system may be a personal computer, a workstation, a legacy-type system, or any other type of data processing system known in the art. The system includes a main memory 100 that is interactively coupled to one or more Instruction Processors (IPs) 102a and 102b. The memory may also be directly or indirectly coupled to one or more user interface devices 104a and 104b, which may include dumb terminals, personal computers, workstations, sound or touch activated devices, cursor control devices such as mice, printers, or any other known device used to provide data to, or receive data from, the data processing system.

A DataBase Management System (DBMS) 106 is loaded into main memory 100. This DBMS, which may be any DBMS known in the art, manages, and provides access to, a database 108 (shown dashed). The database may be stored on one or more mass storage devices 110a and 110b. Mass storage devices may be hard disks or any other suitable type of non-volatile or semi non-volatile device. These mass storage devices may be configured as a Redundant Array of Independent Disks (RAID). As known in the art, this configuration provides a mechanism for storing multiple copies of the same data redundantly on multiple hard disks to improve efficient retrieval of the data, and to increase fault tolerance. Battery back-up may be provided, if desired. The transfer of data between mass storage devices and DBMS is performed by Input/Output Processors (IOPs) 112a and 112b.

A transaction processing system 114 may be coupled to DBMS 106. This transaction processing system receives queries for data stored within database 108 from one or more users. Transaction processing system formats these queries, then passes them to DBMS 106 for processing. DBMS 106 processes the queries by retrieving data records from, and storing data records to, the database 108.

The system of FIG. 1 may further support a client/server environment. In this case, one or more clients 120 are coupled to data processing system 101 via a network 122, which may be the Internet, an intranet, a local area network (LAN), wide area network (WAN), or any other type of network known in the art. Some, or all, of the one or more clients 120 may be located remotely from data processing system.

It will be appreciated that the system of FIG. 1 is merely exemplary, and many other types of configurations may usefully employ the current invention to be described in reference to the remaining drawings.

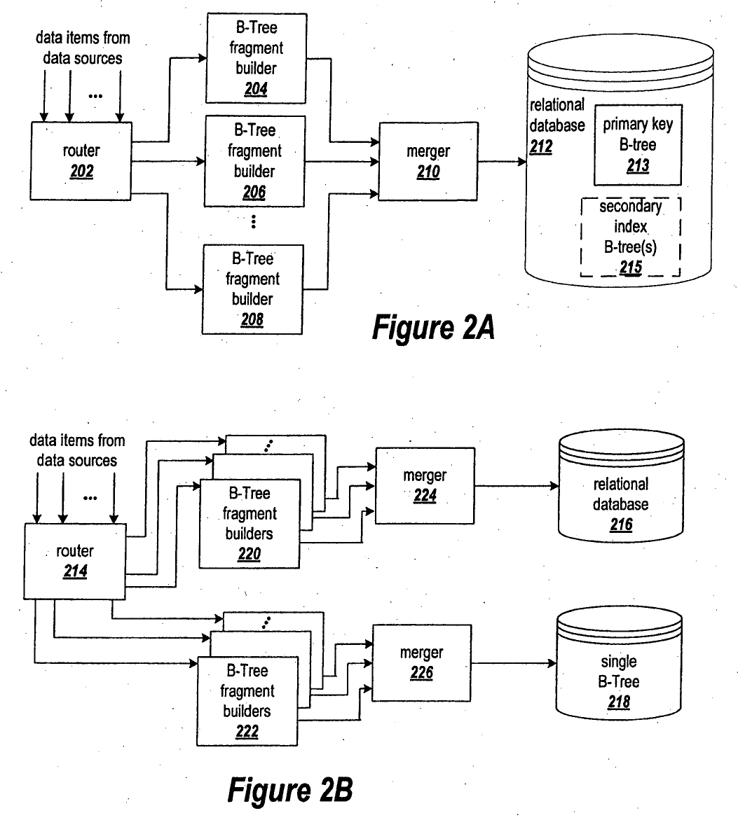

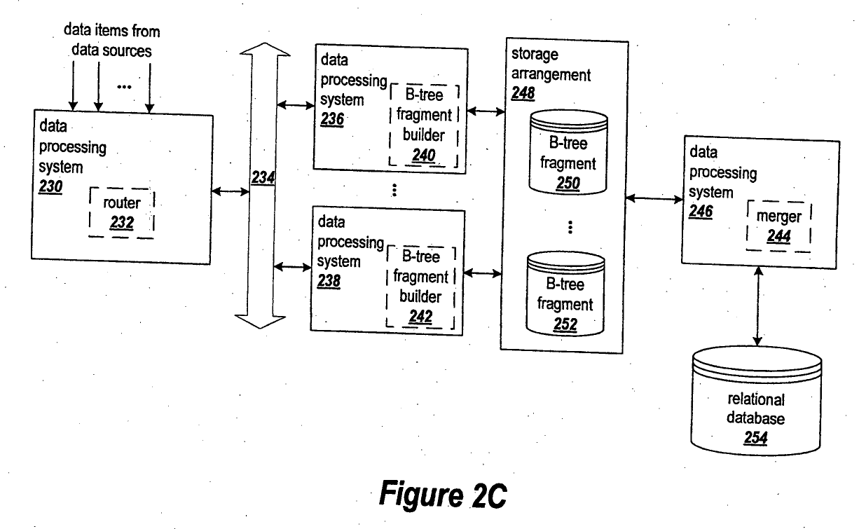

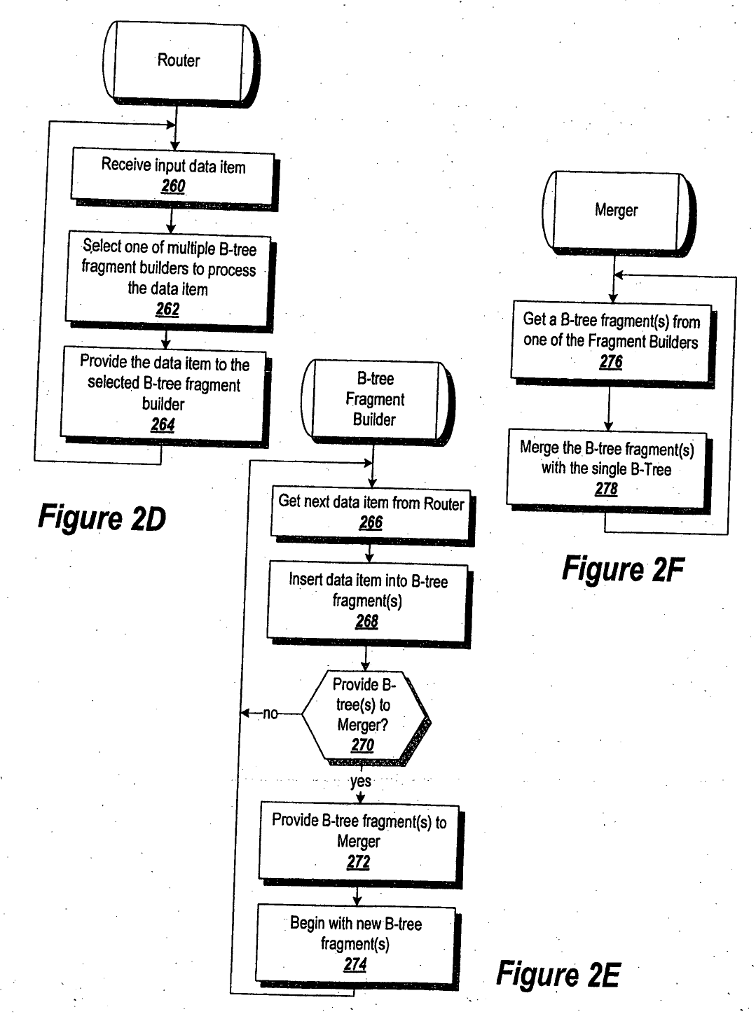

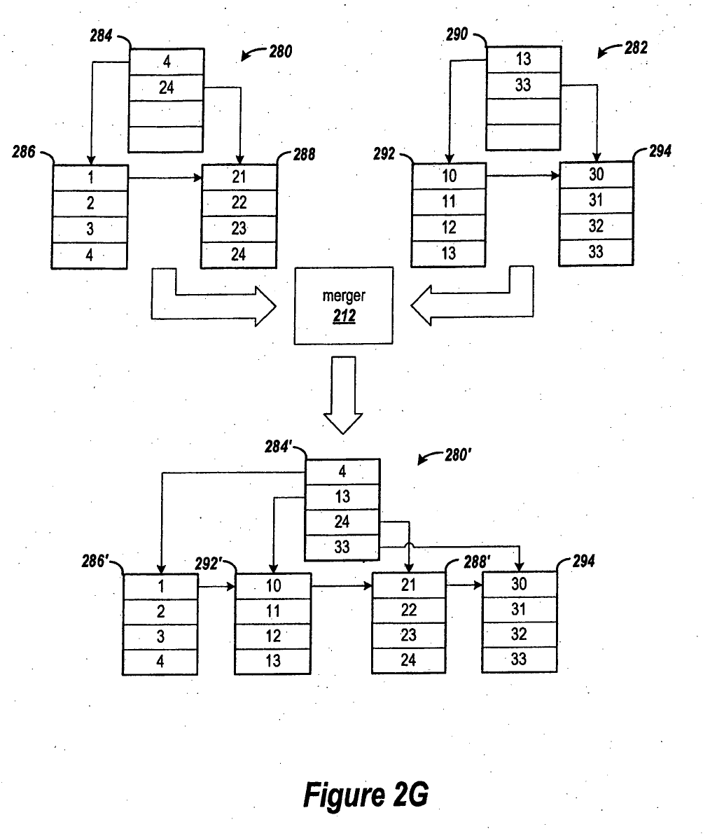

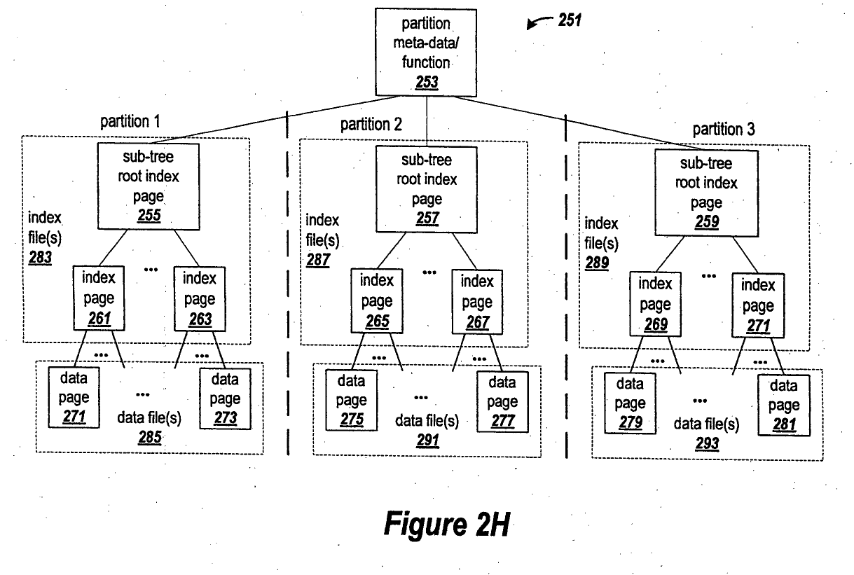

With reference to FIGS. 2A, 2B, and 2C, which are described below, instances of database 108 are relational database 212, 216, 218, and 254. Each of these databases 212, 216, 218, and 254 may be accessed using the data processing system of FIG. 1. In example embodiments, instances of data processing system 101 may be used in implementing routers 202 and 214; B-Tree fragment builders 204, 206, . . . 208, 220, and 222; components for merging 210, 224, and 226; and data processing systems 230, 236, 238, and 240. In each instance, database management system 106 and database 108 are optional, although mass storage 110a and 110b are required.

FIG. 2A is a functional block diagram that shows a router, multiple B-tree fragment builders, and a component for merging for building a relational database in accordance with various embodiments of the invention. A router 202 receives data from one or more sources. The router chooses one of B-tree fragment builders 204, 206, . . . 208 to further process the incoming data. In the example illustration, router 202 is shown as a single instance. However, for greater capacity, multiple routers may be employed, with each router processing a subset of the data sources or each router passing data items to specialized B-tree fragment builders, for example.

Each B-tree fragment builder creates a B-tree fragment to be combined into a single primary key B-tree. In addition, if the relational database has a secondary index each B-tree fragment builder creates a secondary index fragment to be merged into the corresponding secondary index B-tree of the relational database. Multiple B-tree fragment builders working in parallel to organize the incoming data items into B-tree fragments for the primary key B-tree and any secondary index B-trees helps to offload processing from the main database engine (e.g., FIG. 1, 106).

The B-tree fragment builder has meta-data for building a B-tree fragment. The meta-data includes column identifiers and corresponding specifications of data types, an indication of which column(s) are the key(s), and the key sort direction. The examples described herein are in reference to the keys being a strictly monotonically increasing sequence. However, those skilled in the art will recognize that in other applications the keys could alternatively be strictly monotonically decreasing or some suitable combination of increasing and decreasing. Each B-tree fragment builder is configured for controlling the point at which it stops building the current B-tree fragment. Examples include numbers of items processed, a period of time, values of data items, size of the B-tree fragment and others which will be recognized by those skilled in the art. The B-tree fragment builders further have access to mass storage and memory for building the fragments.

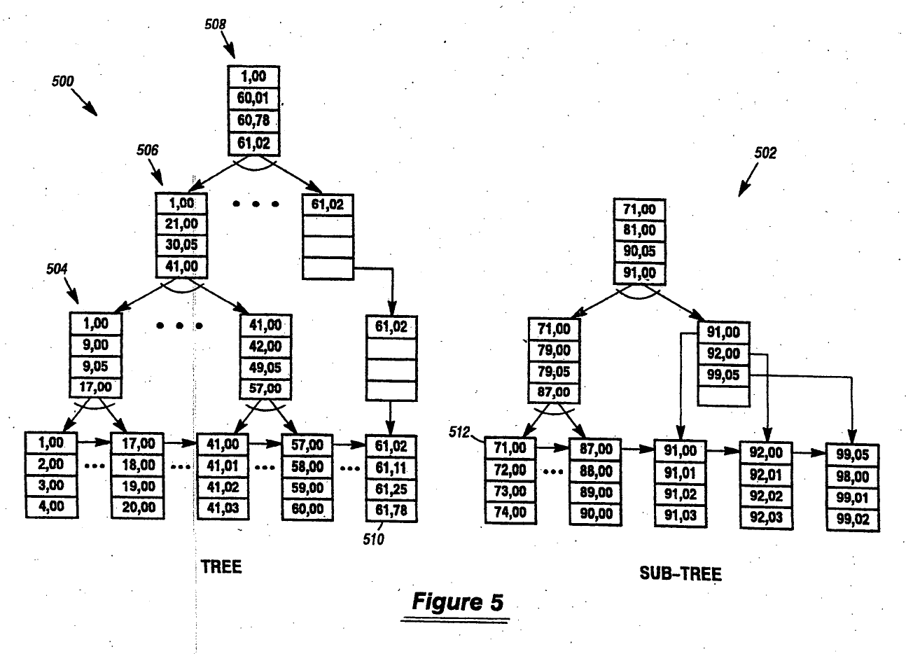

Each B-tree fragment builder passes B-tree fragments to the component for merging 210, which merges each B-tree fragment with the proper index of the relational database 212. For example, primary key B-tree fragments are merged with the primary key B-tree 213 (or “primary index”). Depending on the number of secondary indices, the component for merging may receive as input one or several B-tree fragments at a time from each B-tree fragment builder. A secondary-key B-tree fragment is merged with the appropriate one of the secondary-key B-tree(s) 215. A user application or analysis program queries the relational database 212 for information. One or more approaches that the component for merging could follow are shown in FIGS. 5-8 and described in the corresponding paragraphs below.

Different implementations and embodiments of the invention may have different granularities for each instance of each processing component 202, 204, 206, . . . 208, and 210. For example, in one embodiment each instance may be a thread (not shown) within a process. In an alternative embodiment each instance may be a separate process (not shown) executing within a single operating system image. In yet another embodiment, each instance could be within a different virtual system image (not shown). A different physical partition (not shown) of a data processing system could host each instance in another embodiment, each partition having its own set of one or more processors, memory, and input/output resources. A separate physical computing system could be used to host each instance in yet another embodiment, with each physical computing system having its own set of processor, memory, and I/O resources, along with an operating system for managing those resources. Those skilled in the art will recognize that the aforementioned alternatives may be employed in various combination in order to achieve design objectives. To provide the desired capacity level each instance or each processing component executes in parallel irrespective of the architectural choices made in implementing embodiments of the invention.

The means by which data is transferred from the router 202 to the B-tree fragment builders 204, 206, . . . 208 and from the B-tree fragment builders to the component for merging 210 may vary according to design requirements. For example, the transfer could be through a shared memory segment (not shown) or through a shared file (not shown) on the same physical computing system or across multiple virtual or physical computing systems. The transfer could be through a communications protocol either standardized, specialized, or hybrid. Those skilled in the art will recognize that the data transfer medium needs sufficient capacity to handle the volume of output generated by each of the components in order to minimize the latency between the time a data item is received by the router and the time that data item can be retrieved from the relational database 212.

FIG. 2B is a functional block diagram that shows an alternative embodiment of the invention in which multiple components for merging create respective B-trees from B-tree fragments. In this embodiment, router 214 chooses between relational databases 216 and 218 for inserting an incoming data items. For example, relational database 216 may be a small relational database of tens of terabytes and relational database 218 may be a larger database of hundreds of terabytes. The number of databases, as well as the contents and sizes thereof, are application dependent.

In the embodiment of FIG. 2B, the router 214 determines the targeted one of relational databases 216 and 218, and then chooses one of multiple B-tree fragment builders based on the chosen database. For example, B-tree fragment builders 220 are associated with database 216, and B-tree fragment builders 222 are associated with database 218. The B-tree fragment builders 220 provide B-tree fragments to component for merging 224, and B-tree fragment builders 222 provide B-tree fragments to component for merging 226. The components for merging 224 and 226 combine the B-tree fragments with the B-trees of databases 216 and 218, respectively, as discussed above.

FIG. 2C is a block diagram that shows an embodiment of the invention in which individual physical data processing systems are used to host the router, B-tree fragment builders, and the component for merging, and the B-tree fragment builders store the B-tree fragments to a storage arrangement that is shared with the component for merging. In an example application such as the storing of satellite telemetry data in a relational database, the system 230 that hosts the router 232 may be a 32 processor Unisys ES7000 system, for example.

System 230 may be coupled via a network 234, e.g., a LAN or WAN, to individual systems 236 and 238, which host the B-tree fragment builders 240 and 242, respectively. For an example application, the systems 240 and 242 may be a system such as a Unisys ES3000 4-processor system. The B-tree fragment builders build B-tree fragments in a format suitable for the component for merging 244 which is hosted by system 246. In an example embodiment, the internal record and page format for the Enterprise Relational Database Server for ClearPath OS2200 (RDMS) may be used.

After processing the data items into one or more B-tree fragments, each B-tree fragment builder writes its output to a file on a shared storage arrangement 248. For example, B-tree fragment builder 240 writes to file 250, and B-tree fragment builder 242 writes to file 252. The storage arrangement 248 may be any system that provides sufficient storage capacity and access bandwidth. The arrangement may be an array of shared disks or a storage area network, for example. The component for merging 244 reads each file containing each B-tree fragment and merges the fragments into the relational database 254. The system 246 that hosts the component for merging 244 may be a Unisys Dorado 300 mainframe which writes the B-tree data to the Enterprise Relational Database Server for ClearPath OS2200 (RDMS) database. Those skilled in the art will recognize that the named systems are but examples and there are many alternative systems that may be suitable for various applications.

FIG. 2D is a flowchart of an example process performed by the router in accordance with various embodiments of the invention. At step 260, the router receives an input data item which will be inserted in a relational database. The router selects a B-tree fragment builder at step 262.

Selecting the B-tree fragment builder can be based on any or a combination of several criteria, including, for example a count of data items (e.g., the router sends some number of successively received data items to one fragment builder and after that sends some number of data items to another fragment builder, etc.), a data attribute (e.g., data items from the northern hemisphere go to one builder and from the southern hemisphere go to another builder), and time (e.g., the data items that arrive in the next n seconds go to the next builder). Any selection technique may be employed which supports routing some number of adjacent monotonically increasing primary key valued data items to the same B-tree Fragment Builder. At step 264, the router provides the data item to the selected B-tree fragment builder. In an example embodiment the data items may be transmitted over a network using conventional data transfer protocols.

FIG. 2E is a flowchart of an example process performed by each B-tree fragment builder component in accordance with various embodiments of the invention. At step 266, the B-tree fragment builder receives a data item to process from the router. One or several data sources (data streams) may provide data items for inserting in the database. Each data source may have different information, different formats, and different arrival rates. If necessary, the B-tree fragment builder converts the data items to the required format of the underlying relational database.

In one embodiment, the B-tree fragment builder obtains the primary key values from data in the incoming data items. For example, in the case of satellite pictures, a primary multi-column key value may include the latitude, longitude, and timestamp. In the case of phone call logging, a primary multi-column key value may include the calling phone number, the called phone-number, and the starting time of the conversation.

In one embodiment the B-tree fragment builders are configured for processing particular ranges of the primary key value. For example, there might be a table that says a particular B-tree fragment builder is to process data items that map to a longitude/latitude square defined by two coordinates. Alternatively, the builder may be designated to process data items from time T1 to T2. At step 268, the B-tree fragment builder inserts the data item into a B-tree fragment. The insertion of the data item follows conventional insertion methods for inserting an item in a B-tree.

At decision step 270, the B-tree fragment builder determines whether or not it is time to provide the fragment to the component for merging. Each B-tree fragment builder buffers some number of incoming data items from which it builds the internal record and page formats and control information for the target database management system's database 140. The amount of data buffered can be based on several criteria including, for example, the size of the target database's data and index, pages and the available memory and/or a time duration. In terms of page size, to optimize retrieval speed it would be desirable to fill each data page and each index page with as many records as will fit. For the time duration, each B-tree fragment could contain the data items received by the builder in one second. In this case, the processing of the router and the B-tree fragment builder must be synchronized to ensure no data loss. Any buffering criteria may be employed which maximizes the size of the B-tree fragment created by the process and minimizes the latency between the time a data item appears for insertion and the time the data item can be retrieved from the relational database.

In one embodiment, the output from each B-tree fragment builder is a fragment of the primary key B-tree and a fragment of each secondary index B-tree. In another embodiment, the output from each B-tree fragment builder is a database partition and its associated local secondary indices. In a third embodiment, the output from each B-tree fragment builder is a fragment of a database partition.

At step 272, the B-tree fragment builder provides the primary key fragment to the component for merging along with any associated B-tree fragments for secondary indices. The builder begins a new B-tree fragment at step 274 after providing the previous fragment to the component for merging. The process returns to step 266 to process the next received data item.

FIG. 2F is a flowchart of an example process performed by the component for merging in accordance with various embodiments of the invention. The component for merging takes the B-tree fragments created by each B-tree fragment builder and merges them into the database primary key index and secondary index B-trees.

At step 276, the component for merging gets a B-tree fragment provided by one of the B-tree fragment builders. Various known signaling or data communication methods may be used to indicate to the component for merging that a fragment is available to be processed. The component for merging merges the B-tree fragment(s) with the B-trees of the relational database at step 278. In addition the combining of a B-tree fragment with a single B-tree of the database, part of the merging process is to store the resulting B-tree so that other applications or processes may thereafter access the updated database.

FIG. 2G shows the merging of example B-trees into a single B-tree. For purposes of the example, it may assumed that B-tree 280 is the main B-tree of the relational database into which B-tree fragment 282 is to be merged. B-tree 280 includes index page 284 and data pages 286 and 288, and fragment 282 includes index page 290 and data pages 292 and 294. The resulting main B-tree 280′ has index page 284′, which includes the index records from fragment index page 290.

The data page 286 from the main B-tree 280 is designated as data page 286′ in the merged B-tree 280′ since is linked to data page 292′, which is the data page 292 from the fragment 282. Similarly, data page 288′ is linked to data page 294. Those skilled in the art will appreciate that the merging of a secondary index B-tree fragment with the main B-tree for a secondary index would follow a similar pattern.

As mentioned above, the output from each B-tree fragment builder may be a partition of a database or a fragment of a partition. Partitioning a database enhances concurrent access and database recoverability by storing portions of the database in different files. For example, the partitions are often defined by ranges of primary key values with separate sets of files established for the partitions as defined by the ranges. The database management system merges a partition or a partition fragment received from a B-tree fragment builder with the main database in a manner similar to that described above for merging a B-tree fragment with the main B-tree of the database. The merging, however, is confined to the files of the target partition.

FIG. 2H shows an example database 251 having three partitions. At the top of the database is block 253 which sets forth the meta-data and/or functions that define the partitions. Those skilled in the art will recognize that different DBMSs have different means for defining and managing partitions. Some DBMS support processing of commands that define partitions and others require a partitioning function, which is used by a partitioned schema, which is used by the partitioned table. Thus, block 253 represents the collection of data and/or functions that define the partitions.

The example database 251 has three partitions, partition 1, partition 2, and partition 3. Each partition has a respective sub-tree root index page (255, 257, and 259) and a respective set of index pages, 261 . . . 263 for sub-tree 255, 265 . . . 267 for sub-tree 257, and 269 . . . 271 for sub-tree 259. Each index page references one or more data pages. Index page 261 references data page 271, index page 263 references data page 273, index page 265 references data page 275, index page 267 references data page 277, index page 269 references data page 279, and index page 271 references data page 281.

One feature of a partitioned database is the use of separate files for the different partitions. An example implementation also makes use of separate files for the indices and the data files. In the example database 251, one or more index files 283 are used to store the index pages of partition 1, and one or more data files 285 are used to store the data pages of partition 1. Separate index files 287 and 289 and data files 291 and 293 are used for partitions 2 and 3.

In one embodiment each B-tree fragment builder may provide a partition to the component for merging for merging with the database. For example, one builder may be assigned to build partition 3. When the component for merging receives the partition, the files of that new partition are stored according to implementation requirements with appropriate file references from the index file(s) to the data file(s) and between the data file(s). Also, the component for merging stores a reference to the sub-tree root index page (e.g., 259) in the partition meta-data/function 253.

In merging a fragment of a partition with a B-tree the component for merging operates as described above with reference to FIGS. 2F and 2G.

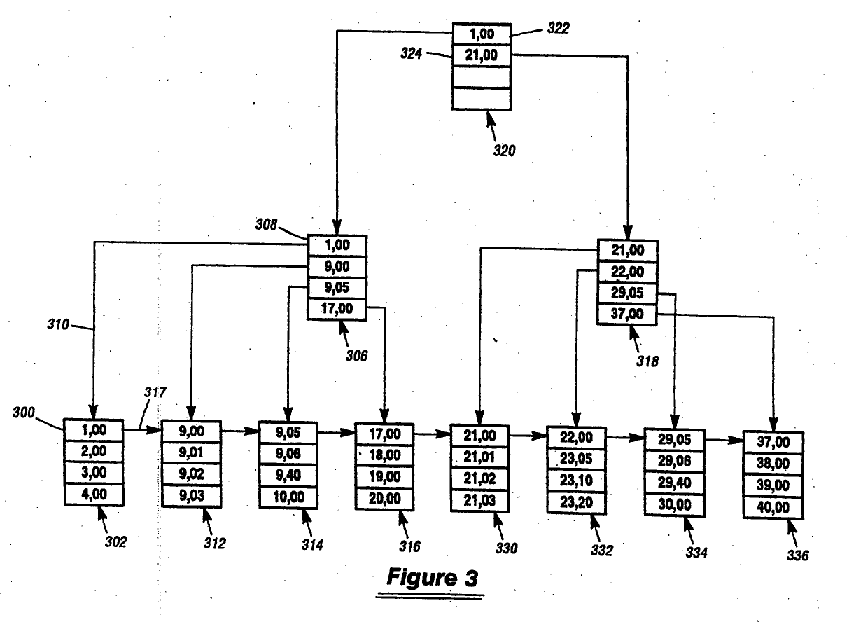

FIG. 3 shows an example B-tree constructed from an input stream of sorted records. Each B-tree fragment builder component receives an input stream of data items, which are sorted by virtue of the new primary key value assigned to each new data item. Thus, FIG. 3 shows an example B-tree constructed by a B-tree fragment builder component in accordance with an example embodiment of the invention.

The first received record 300 is stored in a leaf node created on page 302. When four records have been stored on this page so that the page is considered full, the first non-leaf node is created on page 306. The first entry 308 on this page points to page 302, and stores the index value “1.00” of the first record on page 302. In another embodiment, this entry might include the index value “4.00” obtained from the last entry on page 302. In another embodiment, this entry may include both index values “1.00” and “4.00”. Entry 308 further stores a pointer 310 to page 302.

After page 302 is created, additional leaf nodes are created on pages 312, 314, and 316, each of which is pointed to by an entry on page 306. According to one embodiment, at least one of the entries on each of these pages 302, 312, 314, and 316 stores a pointer to the node appearing next in the sort order based on the index values. For example, page 302 stores a pointer 317 to page 312, and so on. This allows a search to continue from one leaf node to the next without requiring the traversal of the tree hierarchy. This makes the search more efficient.

After page 306 has been filled, a sibling is created for this page at the same level of the tree hierarchy. This sibling, non-leaf node is shown as page 318. In addition to creating the sibling, a parent node is created pointing to both page 306 and the newly created sibling on page 318. This parent node, which is shown as page 320, includes an entry 322 pointing to, and including the index from, the first record of page 306. Similarly, entry 324 points to, and includes the index from, the first record of page 318.

Next, additional leaf nodes are created on pages 330, 332, 334, and 336 in the foregoing manner. Thereafter, page 318 is full, and another sibling will be created for page 318 which is pointed to by an entry of page 320. In a similar manner, when page 320 is full, both a sibling and a parent are created for page 320 and the process is repeated. This results in a tree structure that is balanced, with the same number of hierarchical levels existing between any leaf node and the root of the tree.

The above-described process stores records within leaf nodes. In an alternative embodiment, the records may be stored in storage space that is pointed to, but not included within, the leaf nodes. This may be desirable in embodiments wherein the records are large records such as Binary Large OBjects (BLOBs) that are too large for the space allocated to a leaf node.

In the above exemplary embodiment, records are sorted according to a single index field. Any available sort mechanism may be used to obtain this sort order prior to the records being added to the database tree. An alternative embodiment may be utilized wherein records are sorted according to other fields such as a primary key value, a secondary index, a clustering index, a non-clustering index, UNIQUE constraints, and etc. as is known in the art. Any field in a database entry may be used for this purpose. Additionally, multiple fields may be used to define the sort order. For example, records may be sorted first with respect to the leading column of the key, with any records having a same leading column value further sorted based on the second leading key value, and so on. Any number of fields may be used to define the sort order in this manner.

When the database tree is constructed in the manner discussed above, it may be constructed within an area of memory such as in-memory cache 107 of main memory 100 (FIG. 1). It may then be stored to mass storage devices such as mass storage devices 110a and 110b.

The mechanism described in reference to FIG. 3 results in the construction of a tree that remains balanced as each leaf node is added to the tree. Thus, no re-balancing is required after tree construction is completed, and no data need be shuffled between various leaf and/or non-leaf nodes. Moreover, if tree construction is interrupted at any point in the process, the resulting tree is balanced.

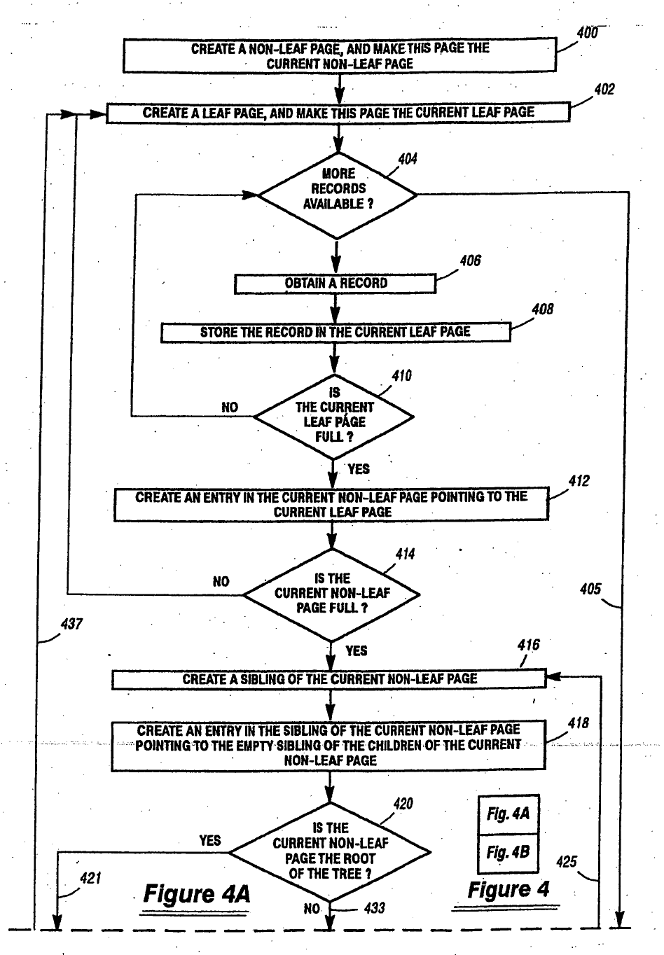

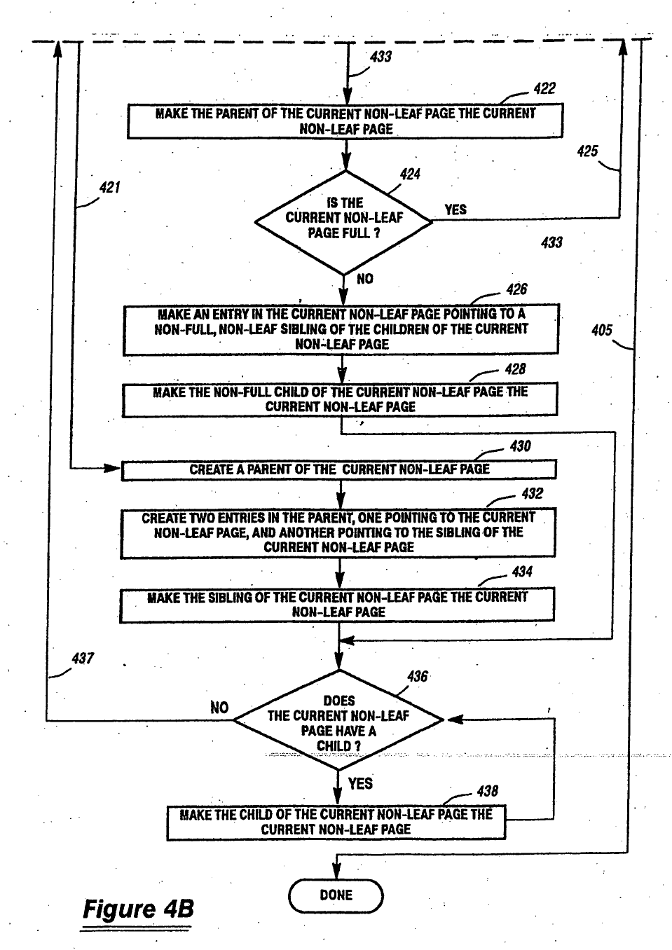

FIGS. 4A and 4B, when arranged as shown in FIG. 4, are a flow diagram illustrating a process by which the example B-tree of FIG. 3 may be constructed. The process of FIGS. 4A and 4B shows an example process followed by a B-tree fragment builder component in inserting a record into the B-tree (FIG. 2E, step 210).

The process of FIG. 4 assumes that records are available in some sorted order for entry into a database table. According to this process, a non-leaf page is created. This page is made the current non-leaf page (400). Next, a leaf page is created. This page is designated the current leaf page (402). In one embodiment, a pointer or some other indicia identifying this current leaf page may be stored within a leaf page adjacent to the current page within the tree. This allows searching to be performed at the leaf node level without traversing to a higher level in the tree. In another embodiment, the links at the leaf node level may be omitted.

Next, if a record is available for entry into the database table (404), the next record is obtained (406). Otherwise, building of the database table is completed, as indicated by arrow 405.

Returning to step 406, when the next record is obtained, this record is stored within the current leaf page (408). If this does not result in the current leaf page becoming full (410), processing returns to step 404.

If storing of the most recently obtained record causes the current leaf page to become full at step 410, an entry is created in the current non-leaf page to point to the current leaf page (412). This entry may include the index value of the first record stored on the current leaf page, as shown in FIG. 3. Alternatively, the entry may store the index value of the last record, or the index values of both the first and last records, on the current leaf page.

Next, it is determined whether the current non-leaf page is full (414). If not, processing may continue with step 402 where another leaf page is created, and is made the current leaf page. Processing continues with this new leaf page in the manner discussed above. If, however, the non-leaf page is full, a sibling is created for the current non-leaf page by allocating a page of storage space (416). If this non-leaf page is at a level in the hierarchy that is not directly above the leaf pages, an entry is created in this sibling. This entry points to the non-full, non-leaf node residing at the next lower level in the hierarchy (418). Because of the mechanism used to fill the pages, only one such non-leaf node will exist. Stated another way, this entry points to the recently created sibling of the children of the current non-leaf page. This step is used to link a newly created sibling at one non-leaf level in the tree hierarchy with a newly created sibling at the next lower non-leaf level in the hierarchy. This step is invoked when the traversal of multiple levels of hierarchy occurs to locate a non-leaf page that is not full. As will be appreciated, this step will not be invoked for any current non-leaf node that is located immediately above the leaf level of the hierarchy.

Next, it is determined whether the current non-leaf page is the root of the tree (420). If not, processing continues to step 422 of FIG. 4B, as shown by arrow 433. In step 422, the hierarchy must be traversed to locate either the root of the tree, or to locate a non-leaf page that is not full. To do this, the parent of the current non-leaf page is made the current page. Then it is determined whether this new current non-leaf page is full (424). If the current non-leaf page is full, processing returns to step 416 of FIG. 4A, as indicated by arrow 425. In this step, a sibling is created for the current non-leaf page, and execution continues as discussed above. Returning to step 424, if the new current non-leaf page is not full, an entry is created in the current non-leaf page. This entry points to a non-full, non-leaf sibling of the children of the current non-leaf page. This non-full sibling is the page created during step 416, and that is at the same level in the hierarchy as the children of the current non-leaf page. This linking step makes this sibling another child of the current non-leaf page.

Next, the tree must be traversed to the lowest level of the non-leaf pages. Therefore, the newly linked non-full child of the current non-leaf page is made the new current non-leaf page (428). If the current non-leaf page has a child (436), then traversal must continue to locate a non-full, non-leaf page that does not have a child. Therefore, the child of the current non-leaf page is made the current non-leaf page (438), and processing continues with step 436.

Eventually, a non-full, non-leaf page will be encountered that does not yet store any entries. This page exists at the lowest level of the non-leaf page hierarchy, and will be used to point to leaf pages. When this page has been made the current non-leaf page, processing may continue with step 402 of FIG. 4A and the creation of the next leaf page as indicated by arrow 437.

Returning now to step 420 of FIG. 4A, if the current non-leaf page is the root of the tree, processing continues with step 430 of FIG. 4B, as indicated by arrow 421. In step 430, a parent is created for this non-leaf page. Two entries are created in the parent, with one pointing to the current non-leaf page, and the other pointing to the sibling of the current non-leaf page, which was created in step 416 (432). The tree must now be traversed to locate a non-leaf page that does not include any entries, and hence has no children. This non-leaf page will point to any leaf node pages that will be created next. To initiate this traversal, the sibling of the current non-leaf page is made the current non-leaf page. If this current non-leaf page has a child (436), the lowest level of the hierarchy has not yet been reached, and the child of the current non-leaf page must be made the new current non-leaf page (438). Processing continues in this manner until a non-leaf page is encountered that does not have any children. Then processing may continue with step 402 of FIG. 4A and the creation of additional leaf pages, as indicated by arrow 437.

The foregoing method builds a database tree from the “bottom up” rather than from the “top down”. The process results in a balanced tree that does not require re-balancing after its initial creation. As a result, users are able to gain access to the tree far more quickly than would otherwise be the case if the tree were constructed, then re-balanced. Moreover, the balanced tree ensures that all nodes are the same distance from the root so that a search for one record will require substantially the same amount of time as a search for any other record.

According to another aspect of the invention, database records may be added to an existing tree structure in a manner that allows a new sub-tree to be created, then grafted into the existing tree. After a tree is created using a portion of the records included within a sorted stream of records, users are allowed to access the tree. In the meantime, a sub-tree structure is created using a continuation of the original record stream. After the sub-tree is created, the pages to which the graft occurs within the tree are temporarily locked such that users are not allowed to reference these pages. Then the sub-tree is grafted to the tree, and the pages within the tree are unlocked. Users are allowed to access the records within the tree and sub-tree. This process, which may be repeated any number of times, allows users to gain access to records more quickly than if all records must be added to a tree before any of the records can be accessed by users. In another embodiment, access to parts of the tree may be controlled using locks on individual records rather than locks on pages.

Some or all of the main tree may be retained in an in-memory cache 107 (FIG. 1), which is an area within the main memory 100 allocated to storing portions of the database table. The sub-tree may also be constructed, and grafted to the tree, within the in-memory cache. The nodes of the tree and sub-tree that are retained within the in-memory cache may be accessed more quickly than if these nodes had to be retrieved from mass storage devices 110a and 110b. Therefore, the grafting process may be completed more quickly if the nodes involved in the grafting are stored in the in-memory cache.

FIG. 5 is a diagram illustrating a main B-tree and a fragment B-tree to be merged with the main B-tree. It may be noted that for ease of reference, not all existing pages of the tree or sub-tree are actually depicted in FIG. 5. For example, it will be understood that in this embodiment, page 504 of tree 500 points to four children, as do each of pages 506 and 508, and so on.

The process of creating tree 500 occurs in a manner similar to that discussed above. A stream of records is received. These records are sorted such that a known relationship exists between the index values of consecutively received records. The records may be stored within tree 500 using the method of FIG. 4 such that a balanced tree is constructed without the need to perform any re-balancing after tree creation has been completed. Users may then be granted access to the data stored within the tree.

Sometime after tree 500 is constructed, more records are received. These additional records are in the same sort order as the records used to construct tree 500. For example, assume each record added to tree 500 has an index value greater than, or equal to, the previously received record. In this case, the stream of records used to build sub-tree 502 will be in a sort order wherein each record has an index value that is greater than, or equal to, the previous record. Moreover, the first record 512 added to tree 502 will have an index value greater than, or equal to, that of the last record 510 added to tree 500, and so on. Thus, the stream of records used to build sub-tree 502 may be viewed as a continuation of the stream used to construct tree 500. Of course, other sort orders may be used instead of that discussed in the foregoing example.

When the additional records are received, these records are added to sub-tree 502. Users may not access these additional records while sub-tree 502 is being constructed. As with the construction of tree 500, sub-tree may be created using the method of FIG. 4 so that the resulting structure is balanced.

After the creation of sub-tree 502 has been completed, it is grafted onto existing tree 500. This involves connecting the root of sub-tree 502 to an appropriate non-leaf page of tree 500. It may further involve adding a pointer from a right-most leaf page of the tree to a left-most leaf page of the sub-tree. To initiate this process, tree 500 is traversed to locate the hierarchical level that is one level above the total number of hierarchical levels in sub-tree 502. In the current example, sub-tree 502 includes three levels from the root to the leaf pages. Therefore, tree 500 is traversed to locate a level that is one greater than this total sub-tree height, or four levels from the leaf pages. In the example, this results in location of the level at which root page 508 resides.

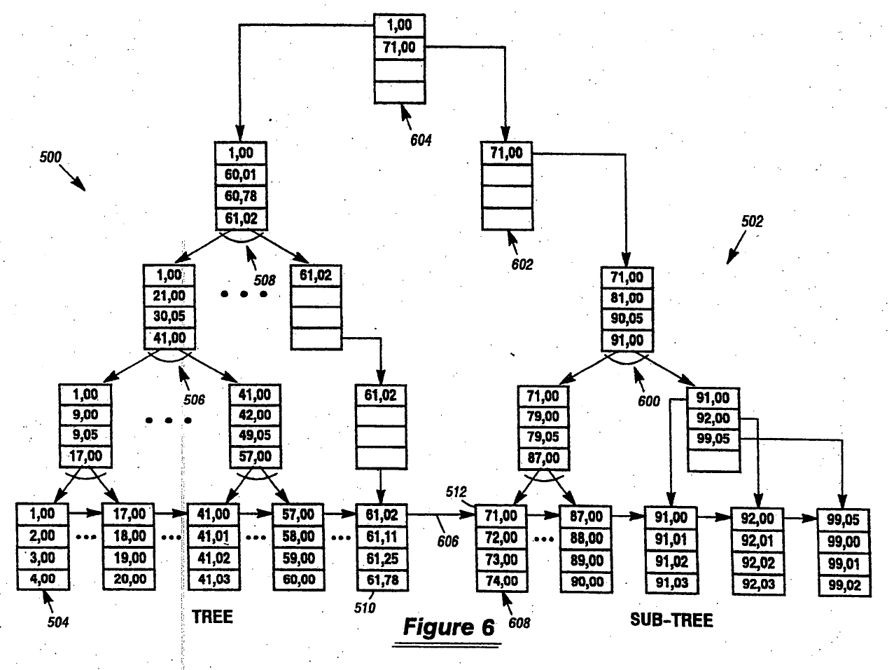

Next, within the located hierarchical level of tree 500, the page that was most recently updated to store a new entry is located. In the current example, there is only a single page 508 at the located hierarchical level, so page 508 is identified. This page becomes the potential grafting point. If this page is not full, sub-tree 502 will be grafted onto tree 500 via page 508. That is, an entry will be created in page 508 to point to the root of sub-tree 502. If this page is full, as is the case in FIG. 5, some other action must be taken to facilitate the grafting process, as is illustrated in FIG. 6.

FIG. 6 is a diagram illustrating the B-tree fragment 502 of FIG. 5 having been merged into the main B-tree 500. As discussed in reference to FIG. 5, a potential grafting point is first located within tree 500. In the current example, the potential grafting point is page 508. If this page were not full, the page would be locked to prevent any other updates and an entry would be created in page 508 pointing to page 600 of sub-tree 502. Page 508 is full, however, such that some other action must be taken to accomplish the grafting process.

A process similar to that employed above may be used to graft sub-tree 502 to tree 500. That is, a sibling is created for page 508. This sibling, shown as page 602, is linked to page 600 by creating an entry pointing to page 600. Next, since page 508 is the root of tree 500, a parent is created for page 508. This parent, shown as page 604, is linked both to pages 508 and 602 by creating respective entries pointing to these pages.

During the grafting process discussed above, when a new sibling or parent node is created, that new node is locked. Users are prevented from retrieving, or updating, any data stored within a new node until the grafting process is complete. This prevents users from traversing those portions of the tree that are descendants of the new nodes.

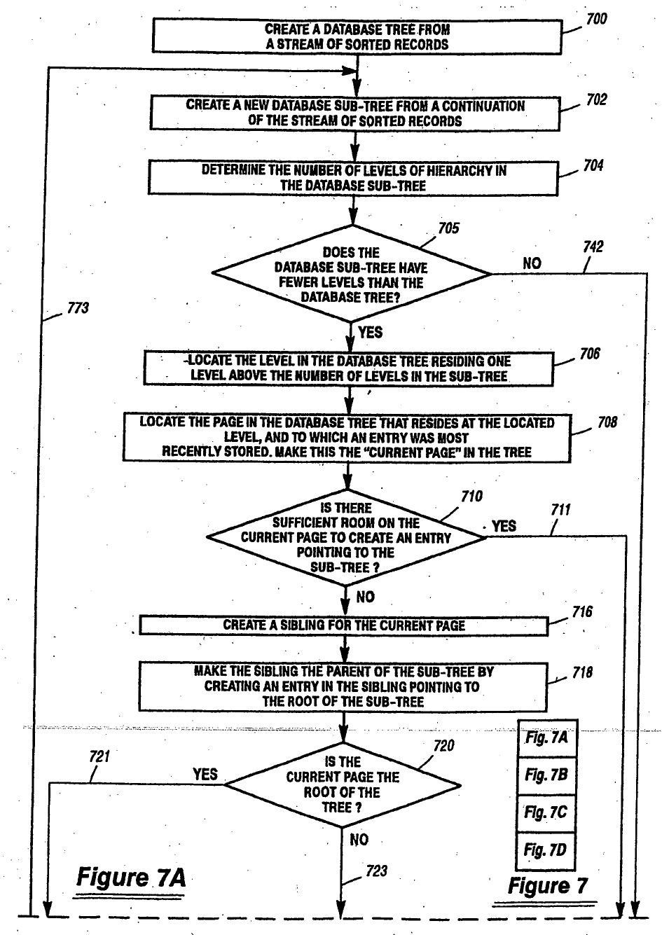

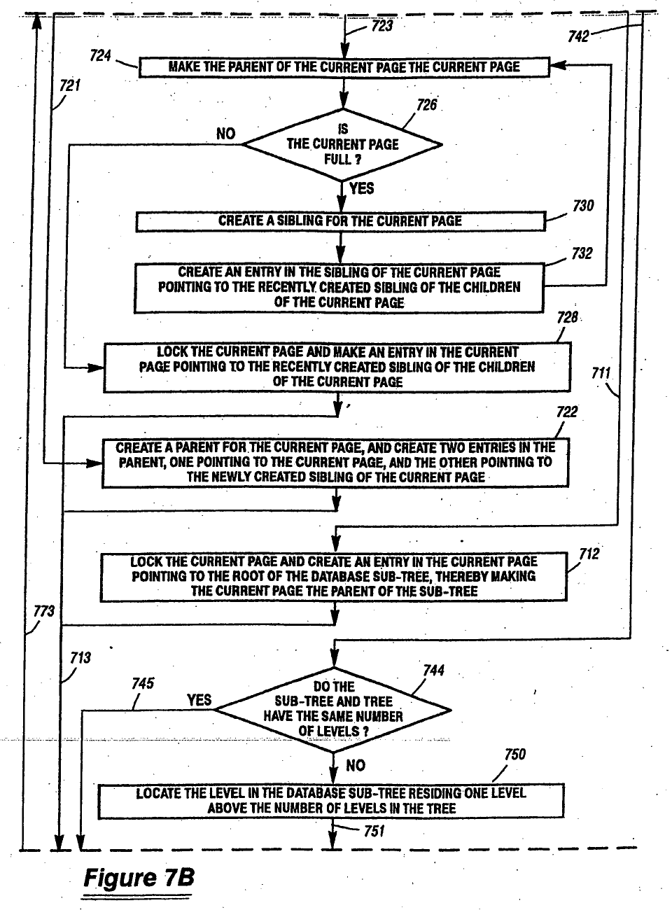

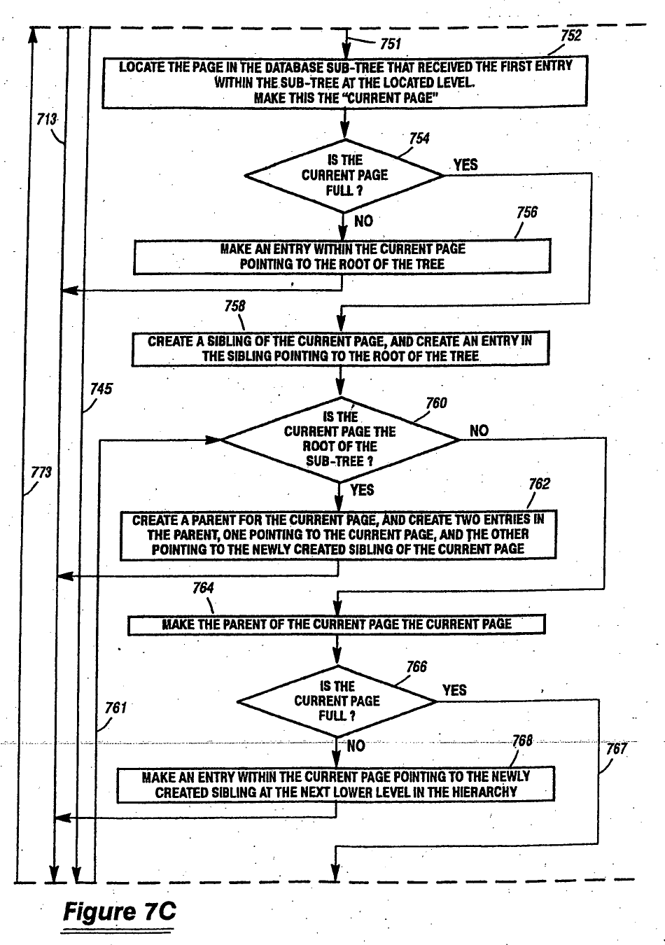

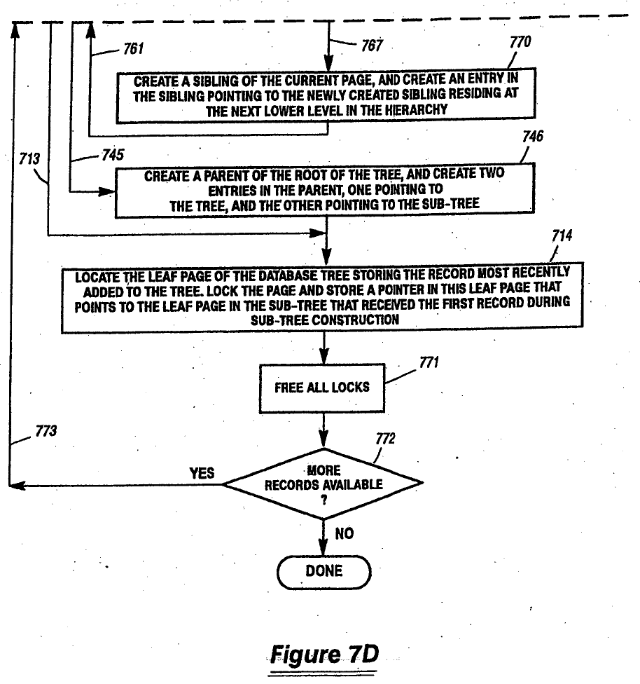

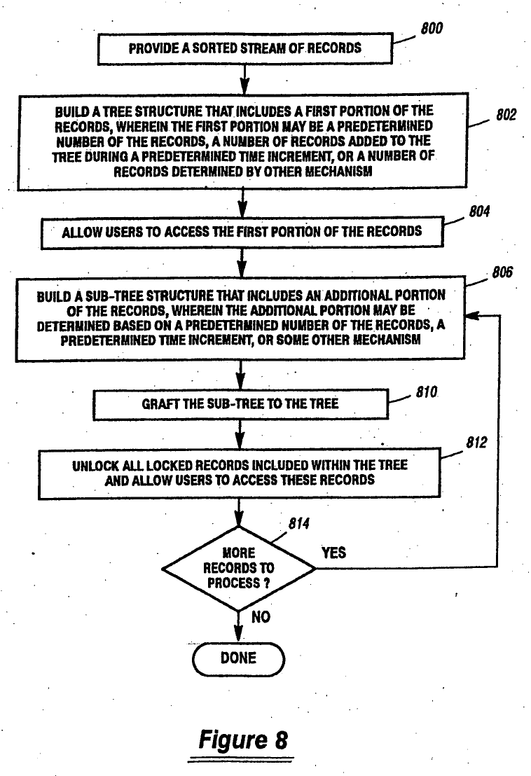

It will be noted that the specific actions used to complete the linking process depend on the structure of the tree. For example, the tree to which the sub-tree is being grafted may include many more hierarchical levels than are shown in FIG. 6. Moreover, many of these levels may have to be traversed before a non-full node is located to complete the graft. Finally, it may be noted that the process discussed above will be somewhat different if the sub-tree includes more hierarchical levels than the original tree structure. In that case, grafting occurs in a similar manner, except that during the grafting process, the tree is grafted into the sub-tree, as will be discussed further below. Therefore, it will be appreciated that the scenario illustrated in FIG. 6 is exemplary only. One embodiment of a generalized process of creating the graft is illustrated in FIGS. 7A through 7D.

In one embodiment, an additional link may be created at the leaf node level to graft sub-tree 502 to the tree 500. To do this, tree 500 is traversed to locate the leaf page that received the last record in the stream during tree creation. This leaf page of the tree is then linked to the page of the sub-tree that received the first record during sub-tree creation. In the current illustration, this involves linking leaf page 510 at the right edge of tree 500 to leaf page 608 at the left edge of sub-tree 502, as shown by pointer 606. This pointer may be formed by storing an address, an offset, or any other indicia within page 510 that uniquely identifies page 608.

FIGS. 7A through 7D, when arranged as shown in FIG. 7, are a flow diagram illustrating one embodiment of the process of merging a B-tree fragment onto a main B-tree in a manner that maintains a balanced tree structure. First, a tree structure is created for use in implementing a database table (700). In one embodiment, this tree structure is created from a sorted stream of records according to the process illustrated in FIG. 4. After creation of the original tree, users may be allowed to access the records stored within the tree. Next, a sub-tree may be created from a continuation of the original sorted stream of records. The sub-tree is therefore sorted with respect to the initially received stream of records (702). This is as shown in FIG. 6. In one embodiment, this sub-tree is created using the process of FIG. 4, although this need not be the case, as will be discussed further below.

Next, it is determined how many hierarchical levels are included within the sub-tree and within the sub-tree (704). If more levels of hierarchy exist in the tree (705), processing continues with step 706, where the tree is traversed to locate the level in the hierarchy that is one level about the height of the sub-tree. Next, within the located level of hierarchy of the tree, the last updated page is located (708). This will be referred to as the “current page”. In the current embodiment, this will be the right-most page residing within the located level. If space is available within the current page (710), processing continues to step 712 of FIG. 7B, as indicated by arrow 711. At step 712, the current page is locked to prevent user access. That is, users are prevented from either reading from, or writing to, this page. Then an entry is created within this page that points to the root of the sub-tree (712). This effectively grafts the sub-tree into the tree structure, making the current page the parent of the root of the sub-tree.

Next, processing continues with step 714 of FIG. 7D, as indicated by arrow 713. At step 714, a link may be created to graft the tree to the sub-tree at the leaf page level. This may be accomplished by locating the leaf page at the right-hand edge of the tree. This is the page that stores the record most recently added to the tree. The located leaf page is locked to prevent user access, and an indicator is stored within this page that points to, or otherwise identifies, the leaf page at the left-hand edge of the sub-tree, which is the leaf page in the sub-tree that was first to receive a record when the sub-tree was created (714). The indicator stored within the leaf page of the tree may comprise an address, and address offset, or any other indicia that may be used to uniquely identify the leaf page of the sub-tree. This links the leaf node at the right edge of the tree with the leaf node at the left edge of the sub-tree. In embodiments that do not include links at the leaf page level, this step may be omitted. This concludes the grafting process.

After the grafting process has been completed, all locks that have been invoked on pages within the tree are released (771). This allows users to access all records within the current tree structure, including all records that had been included within the sub-tree, and which are now grafted into the tree. Finally, if any more records are available to be added to the tree, processing may return to step 702 of FIG. 7A where another sub-tree is created for grafting to the tree, a shown by step 772 and arrow 773.

In one embodiment, each sub-tree may be created to include a predetermined number of records. In another embodiment, each sub-tree may be created to include a number of records that may be processed during a predetermined time interval. Any other mechanism may be used to determine which records are added to a given sub-tree.

Returning to step 710 of FIG. 7A, if sufficient space is not available on the current page to create another entry, the sub-tree must be grafted to the tree using a process similar to that shown in FIG. 4. That is, a sibling is created for the current page (716). An entry is created within this sibling that points to the sub-tree, thereby grafting the sibling to the sub-tree (718). If the current page is the root of the tree (720), processing continues to step 722 of FIG. 7B, as indicated by arrow 721. In step 722, a parent is created for the current page. A first entry is created in the parent pointing to the current page, and another entry is created within the parent pointing to the newly created sibling of the current page. Next, processing may optionally continue with step 714 of FIG. 7D, as indicated by arrow 713. In step 713, the tree is linked to the sub-tree at the leaf level, as discussed above.

Returning to step 720 of FIG. 7A, if the current page of the tree is not the root, processing continues to FIG. 7B, as indicated by arrow 723. The tree must be traversed to find a page at a higher level in the hierarchy that is capable of receiving another entry that will graft the sub-tree to the tree. Therefore, in step 724 of FIG. 7B, the parent of the current page is made the new current page. If this current page is not full (726), the sub-tree may be grafted to the tree at this location. To accomplish this, the current page is locked to prevent user access to the page during the grafting process. An entry is then created in the current page that points to the newly created sibling that exists at the next lower level of the hierarchy (728). This grafts the sub-tree to the tree. Processing may optionally continue with step 714 of FIG. 7D to link the sub-tree to the tree at the leaf level, and the method is completed.

Revisiting step 726, if the new current page is full, a sibling must be created for the current page (730). An entry is created in this sibling that points to the newly-created sibling that resides at the next lower level in the hierarchy (732). Then the process must be repeated with step 724. That is, tree traversal continues until either a non-full page is located to which the sub-tree may be grafted, or until the root of the tree is encountered, in which case both the tree and sub-tree are grafted to a newly created tree root.

Next, returning to step 705 of FIG. 7A, it may be possible for the sub-tree to have the same number, or more, levels of hierarchy, than the tree. In either of these cases, processing continues with step 744 of FIG. 7B, as illustrated by arrow 742. If the sub-tree and tree have the same number of levels of hierarchy (744), processing continues to step 746 of FIG. 7D, as indicated by arrow 745. In step 746, a parent is created for the root of the tree (746). An entry is created in the parent pointing to the tree, and another entry is created pointing to the sub-tree. Optionally, the tree and sub-tree may then be linked at the leaf page level in step 714, as discussed above.

Returning to step 744 of FIG. 7B, if the sub-tree has more levels than the tree, processing continues on FIG. 7B. In this case, the tree will be grafted into the “left-hand” side of the sub-tree. This will require a slightly different approach than if the tree has more levels than the sub-tree. This is because in the current embodiment, it is known that all pages at the “left-hand” edge of the sub-tree (other than the root node) will be full. Additionally, the root node may be full.

To perform the grafting process, the sub-tree is traversed to the hierarchical level that is one level above the root of the tree (750). Processing then continues to FIG. 7C, as indicated by arrow 751. The page residing at the left-hand edge of this sub-tree level is located and made the current page (752). This will be the page within the located hierarchical level that was first to receive an entry when the sub-tree was constructed. Next, it is determined whether this page is full (754). If it is not full, this page is the root node. An entry may be created within the page pointing to the root node of the tree (756), thereby grafting the tree into the sub-tree. Processing then continues with step 714, as indicated by arrow 713.

Returning to step 754, if the current page is full, a sibling must be created for the current page. An entry is created within the sibling pointing to the root of the tree (758), thereby linking the tree to the newly created sibling. Next, if the current page is the root of the sub-tree (760), a parent is created for the current page (762). Two entries are created within this parent, one pointing to the current page, and the other pointing to the newly created sibling of the current page. Processing then concludes by continuing to step 714 of FIG. 7D.

If the current page is not the root of the sub-tree (760), the sub-tree must be traversed until the root is located. To accomplish this, the parent of the current page is made the new current page (764). If this new current page is not full (766), it is known that this new current page is the root of the sub-tree. An entry is created in the current page that points to the newly created sibling at the next lower level in the hierarchy (768). This links the tree to the sub-tree, and processing may continue with step 714 of FIG. 7D.

Otherwise, if the current page is full in step 766, processing continues to FIG. 7D, as indicated by arrow 767. There, a sibling is created for the current page (770). An entry is created in this sibling that points to the newly created sibling at the next lower level in the hierarchy. Processing then continues with step 760 of FIG. 7C, as indicated by arrow 761. The process is repeated until a non-full root of the sub-tree is encountered, or until a full root is located and a new root is created that points to both the sub-tree and the tree. After the sub-tree has been grafted into the tree in this manner, all pages are unlocked, or “freed”, as discussed above (771), and the process of creating additional sub-trees may be repeated for any additional records, as indicated by steps 772, and the possible return to the steps of FIG. 7A, as illustrated by arrow 773. If no additional records are available to process, execution is completed.

The process of building trees incrementally using the foregoing grafting process allows users to access data within the records of the database much more quickly than would otherwise be the case if all records were added to a database tree prior to allowing users to access the data. This is because users are allowed to access records within the tree while a sub-tree is being constructed. After the sub-tree is completed, users are only temporarily denied access to some of the records within the tree while the grafting process is underway, and are thereafter allowed to access records of both the tree and sub-tree. The grafting process may be repeated any number of times. If desired, all sub-trees may be constructed in increments that include the same predetermined number of records, and hence the same number of hierarchical levels. This simplifies the process of FIGS. 7A through 7D, since grafting will always occur the same way, with the sub-tree always being grafted into a predetermined level of the tree hierarchical structure, or vice versa. In another embodiment, sub-trees may be built according to predetermined time increments. That is, a sub-tree will contain as many records as are added to the sub-tree within a predetermined period of time. After the time period expires, the sub-tree is grafted to an existing tree or vice versa, and the process is repeated.

The grafting process discussed above in reference to FIGS. 7A through 7D generates a tree by adding sub-trees from the left to the right. In another embodiment, sub-trees may be grafted to the left-hand edge of the tree. It may further be noted that the exemplary embodiment provides records that are sorted such that each record has an index, key, or other value that is greater than, or equal to, that of the preceding record. This need not be the case, however. If desired, records may be sorted such that the values stored within the search fields are in decreasing order.

It may be further noted that the grafting process described above illustrate an embodiment wherein the resulting tree structure is balanced. However, the grafting process discussed herein may be used to generate unbalanced, as well as balanced, tree structures. For example, assume that an unbalanced tree structure has been created using the prior art tree generation process discussed above. After this tree is created, users may be allowed to access the data records stored within, or otherwise associated with, the leaf pages of this tree. In the mean time, a sub-tree may be created using the same, or a different tree generation process. This sub-tree need not be balanced during the construction process. Assuming the sub-tree does not have as many hierarchical levels as the tree, it may then be grafted into the tree by creating an entry such as may be stored within page 230 of the tree. This entry points to the root of the sub-tree. If no space were available within page 230, and the application does not require that the resulting tree remain balanced, a root node could be created that points to both the tree and the sub-tree. An unbalanced tree structure of this nature may be advantageous if recently added records are being accessed more often than prior added records. A similar mechanism may be used to graft a tree to a sub-tree that has more hierarchical levels than the tree. If required, the resulting tree structure could be re-balanced after the grafting process is completed.

FIG. 8 is a flow diagram illustrating a generalized embodiment of the merging process that creates a balanced tree structure. The process requires that a sorted stream of records is available for building the tree and sub-tree (800). A tree is created that includes a first portion of the records in the sorted stream of records (802). This first portion may, but need not, include a predetermined number of records, or may include a number of records within the stream that is processed within a predetermined period of time. As another alternative, building of the sub-tree may continue until a particular record in the stream is encountered. Any other mechanism may be utilized to indicate completion of the tree or sub-tree construction process.

After the tree is constructed to contain the first portion of records, users are allowed to access the records in the tree (804). Meanwhile, a sub-tree is constructed that includes an additional portion of the records in the sorted stream (806). If desired, this additional portion may contain a predetermined number of records, or a number of records within the stream that is processed within a predetermined time increment. As another example, building of the sub-tree may continue until a particular record within the stream is encountered. Any other mechanism may be used to determine the number of records to add to the sub-tree.

When construction of the sub-tree has been completed, it may be grafted to the tree (810). This grafting process may be accomplished using a mechanism such as described in FIGS. 7A through 7D. Alternatively, a simplified approach may be used that creates a new root that will point to both the tree and the sub-tree. If this latter approach is employed, the resulting tree structure may not be balanced, however.

After grafting is completed, any pages or records that were locked during the grafting process are unlocked so that users may gain access to all records in the updated tree structure (812). If more records remain to be processed (814), execution continues with step (806). Otherwise, processing is completed. If all records in the sorted stream are processed, and additional sorted records thereafter become available for processing, steps 806 through 814 may be repeated to add the additional records to the tree. This assumes the additional records are sorted in a sort order that may be considered a continuation of the original stream of records.

Those skilled in the art will appreciate that various alternative computing arrangements, including one or more processors and a memory arrangement configured with program code, would be suitable for hosting the processes and data structures of the different embodiments of the present invention. In addition, the processes may be provided via a variety of computer-readable storage media or delivery channels such as magnetic or optical disks or tapes, electronic storage devices, or as application services over a network.

The present invention is thought to be applicable to a variety of software systems. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A method for adding data items to a database, comprising:
receiving a plurality of data items, wherein each data item is to be stored under a unique primary key in the database;
in response to each received data item, selecting one of a plurality of fragment builders and providing the received data item as input to the selected fragment builder;
building respective pluralities of B-tree fragments by the fragment builders from the input data items, wherein the fragment builders operate in parallel;
merging the pluralities of B-tree fragments into a single B-tree of the database, and storing the single B-tree.

2. The method of claim 1, wherein building a respective plurality of B-tree fragments includes each fragment builder performing the steps comprising:
building an individual B-tree fragment including two or more input data items;
outputting the individual B-tree fragment for merging; and
repeating the building and outputting for input data items provided to the fragment builder subsequent to the two or more input data items.

3. The method of claim 1, further comprising transmitting the pluralities of B-tree fragments from the fragment builders to a component for merging that performs the merging, wherein the fragment builders execute on one or more processors that are physically separate from one or more processors on which the component for merging executes.

4. The method of claim 1, further comprising:
transmitting a first subset of the pluralities of B-tree fragments from a first subset of the fragment builders to a first component for merging that merges the first subset of the pluralities of B-tree fragments into a first single B-tree; and
transmitting a second subset of the pluralities of B-tree fragments from a second subset of the fragment builders to a second component for merging that merges the second subset of the pluralities of B-tree fragments into a second single B-tree.

5. The method of claim 4, wherein the first subset of the fragment builders execute on one or more processors that are physically separate from one or more processors on which the first component for merging executes, and the second subset of the fragment builders execute on one or more processors that are physically separate from one or more processors on which the second component for merging executes.

6. The method of claim 1, wherein the selecting one of a plurality of fragment builders includes providing a selected number of successively received data items to one fragment builder before selecting a different fragment builder for data items received subsequent to the selected number of successively received data items.

7. The method of claim 1, wherein the selecting one of a plurality of fragment builders includes selecting a fragment builder based on a data value in each received data item.

8. The method of claim 1, wherein the selecting one of a plurality of fragment builders includes providing successively received data items to one fragment builder for a selected period of time before selecting a different fragment builder for data items received subsequent to the selected period of time.

9. The method of claim 1, wherein the pluralities of B-tree fragments include primary-key B-tree fragments and one or more secondary-key B-tree fragments.

10. The method of claim 1, wherein the pluralities of B-tree fragments include B-tree partitions.

11. The method of claim 1, wherein the pluralities of B-tree fragments include fragments of database partitions.

12. A system for adding data items to a database, comprising:
a data processing system for receiving a plurality of data items, wherein each data item is to be stored under a unique primary key in the database;
means, responsive to each received data item, for selecting one of a plurality of fragment builders and providing the received data item as input to the selected fragment builder;
means for generating and storing respective pluralities of B-tree fragments by the fragment builders from the input data items, wherein the fragment builders operate in parallel;
means for merging the pluralities of B-tree fragments into a single B-tree of the database; and means for storing the single B-tree.

13. A system for adding a plurality of data items to a single B-tree of a relational database, wherein each data item is to be stored under a unique primary key in the database comprising:
a first data processing system executing a first operating system and a router, wherein the router receives the plurality of data items, and for each received data item selects one of a plurality of fragment builders and transmits the data item to the selected fragment builder;
at least one second data processing system, each second data processing system coupled to the first data processing system and executing a respective second operating system and one or more of the fragment builders, wherein each of the one or more fragment builders creates B-tree fragments from data items transmitted from the router to that fragment builder and provides the B-tree fragments to a first component for merging; and
a third data processing system coupled to the at least one second data processing system and executing a third operating system and the first component for merging, wherein the first component for merging combines each B-tree fragment provided from a fragment builder into a first single B-tree of a first database.

14. The system of claim 13, wherein each B-tree fragment builder further performs the steps comprising:
building an individual B-tree fragment including two or more input data items;
providing the individual B-tree to the first component for merging; and
repeating the building and providing for input data items provided to the B-tree fragment builder subsequent to the two or more input data items.

15. The system of claim 13, further comprising:
a fourth data processing system coupled to the at least one second data processing system and executing a fourth operating system and a second component for merging, wherein the second component for merging combines each B-tree fragment provided from a fragment builder into a second single B-tree of a second database; and
wherein a first subset of the fragment builders provides a first subset of the pluralities of B-tree fragments to the first component for merging, and a second subset of the fragment builders provides a second subset of the pluralities of B-tree fragments to the second component for merging.

16. The system of claim 13, wherein the router, in selecting a fragment builder, provides a selected number of successively received data items to one fragment builder before selecting a different fragment builder for data items received subsequent to the selected number of successively received data items.

17. The system of claim 13, wherein the router, in selecting a fragment builder, selects a fragment builder based on a data value in each received data item.

18. The system of claim 13, wherein the router, in selecting a fragment builder, provides successively received data items to one fragment builder for a selected period of time before selecting a different fragment builder for data items received subsequent to the selected period of time.

19. The system of claim 13, wherein the B-tree fragments include primary-key B-tree fragments and one or more secondary-key B-tree fragments.

20. The system of claim 13, wherein the B-tree fragments include B-tree partitions.
